(19) United States
(12) Patent Application Publication
(10) Pub. No.: US 2012/0227822 A1
(43) Pub. Date: Sep. 13, 2012

(54) ASSEMBLY FOR REDUCING SLURRY PRESSURE IN A SLURRY PROCESSING SYSTEM

(76) Inventor: Leonard James Humphreys, Roseville Chase (AU)

(21) Appl. No.: 13/496,484

(22) PCT Filed: Sep. 10, 2010
(86) PCT No.: PCT/AU2010/001175

§ 371 Date: Jun. 3, 2012

(30) Foreign Application Priority Data
Sep. 16, 2009 (AU) 2009904499

(51) Int. Cl. B01J 19/00; F17D 3/00

(52) U.S. Cl. 137/12; 422/310

(57) ABSTRACT

An assembly (10) for reducing pressure of slurry exiting an outlet pipe (15) of a supercritical reactor (116), the assembly (10) including a sealed collection vessel (12) and an orifice assembly (14) forming an inlet of the collection vessel (12), wherein the orifice assembly (14) comprises a plurality of orifices (17 to 20) for parallel connection with the reactor outlet pipe (15) such that flow from the outlet pipe (15) can be directed to any one of the orifices (17 to 20).

### TECHNICAL FIELD

The present invention relates to an assembly for reducing slurry pressure in a slurry processing system.

### BACKGROUND OF THE INVENTION

International Patent Application no. PCT/AU2008/000429 (PCT publication no. WO 2009/015409) entitled “Process And Apparatus For Converting Organic Matter Into A Product” co-filed by the applicant discloses a process flow diagram (see FIG. 1) where organic matter (lignite) is converted into a usable fuel product by contact with supercritical liquid. The supercritical liquid can be water or a mixture of water and alcohols.

FIG. 1 discloses a plant 110 taking milled lignite and water and metering these materials into a slurry tank 112 before they are fed to a high pressure pump 114 which sends slurry to the reactor 116. The slurry pump 114 is capable of delivering slurry into the reactor 116 with a pressure of around 250 bar and up to over 300 bar.

The reactor 116 is of a type suitable for the in use containment of supercritical liquid in a reaction zone. This is an aggressive environment both in terms of temperature and pressure. A design working pressure in such a reactor is up to 315 bar at 500° C. with a 300% safety factor. The use of supercritical water (>220 bar and >350° C. and <420° C.) in the reactor 116 converts the lignite into smaller molecules that resemble heavy petroleum fractions, commonly referred to as oil, asphaltenes and pre-asphaltenes, residual char, gas (mostly carbon dioxide) and water. A pressure let down assembly 119 is disclosed at the tail end of the process for reducing the slurry pressure exiting the reactor 116.

The entire disclosure of WO 2009/015409 is incorporated herein by cross-reference.

The present invention relates to the assembly for reducing the slurry pressure in the pressure let down assembly 119.

### SUMMARY OF THE INVENTION

The present invention provides an assembly for reducing pressure of slurry exiting an outlet pipe of a supercritical reactor, the assembly including:

a sealed collection vessel; and

an orifice assembly forming an inlet of the collection vessel, wherein the orifice assembly comprises a plurality of orifices for parallel connection with the reactor outlet pipe, wherein flow from the outlet pipe can be directed to any one of the orifices.

The sealed collection vessel preferably includes a cooling jacket extending around its periphery.

The orifice assembly preferably comprises first to fourth orifices of differing orifice diameters and/or shapes.

Preferably, the first and second orifices are connected to a first valve which is operable to selectively direct flow to one of the first and second orifices, the third and fourth orifices are connected to a second valve which is operable to selectively direct flow to one of the third and fourth orifices, and the first and second valves are connected to a third valve which is operable to selectively direct flow to one of the first and second valves, the third valve being for connection to the reactor outlet pipe.

In one embodiment, the orifice diameter increases from the first orifice to the fourth orifice. Alternatively, two or more of the orifices can have the same orifice diameter.

The sealed vessel preferably contains water in use such that each orifice discharges slurry under water in use. The slurry is preferably fed to the orifices via a slurry pump which is a variable speed positive displacement feed pump.

The orifices can be fixed or variable diameter micro orifices. In another embodiment, respective nozzles are connected to the orifices, the nozzles having different diameters as desired. Alternatively, at least two of the nozzles can have the same orifice diameter.

In another aspect, the present invention provides a method of substantially maintaining slurry pressure exiting an outlet pipe of a supercritical reactor to a desired pressure in an assembly in accordance with the above, the method comprising the steps of:

increasing or decreasing the rate at which the slurry pump feeds the slurry into the orifice assembly; and

selecting an orifice in the orifice assembly having suitable orifice diameter and shape to maintain the desired slurry pressure.

The method preferably includes the step of monitoring slurry pressure at spaced points throughout the processing assembly and, if slurry pressure changes between any two points more than a predetermined amount, increasing or decreasing the slurry pump rate and/or selecting a different orifice in the orifice assembly in response to said pressure change.

Preferably, nozzles are respectively attached to the orifices and the selection step includes selecting a nozzle having a suitable orifice diameter and shape to maintain the desired slurry pressure.

### BRIEF DESCRIPTION OF THE DRAWINGS

Preferred embodiments of the present invention will now be described, by way of examples only, with reference to the accompanying drawings wherein:

FIG. 1 is a process flow diagram from WO 2009/015409 where organic matter is converted into a usable fuel product by contact with supercritical liquid;

FIG. 2 is a schematic diagram of the pressure let down assembly for the process of FIG. 1;

FIG. 3 is a schematic perspective view of the assembly of FIG. 2; and

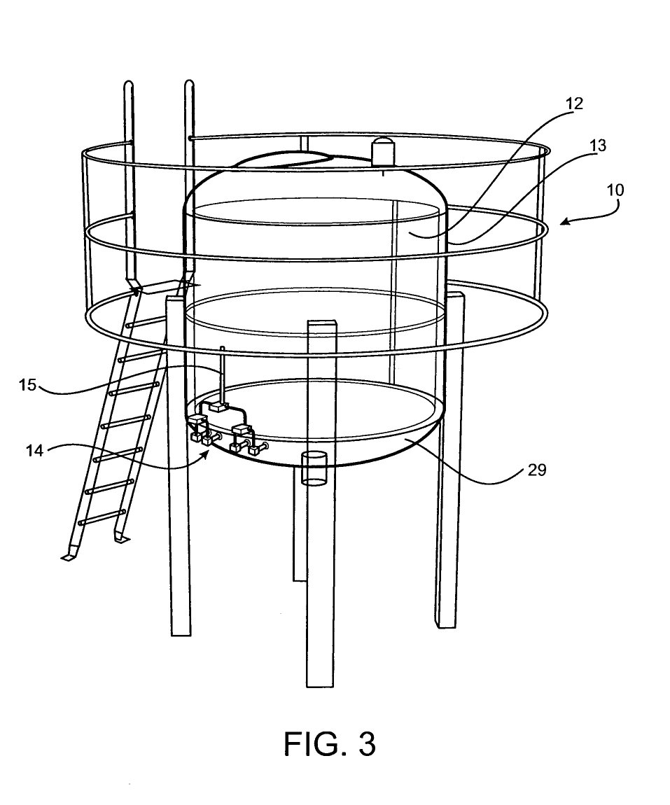

FIG. 4 is an enlarged view of the orifice assembly for the assembly of FIG. 2, where (a) is a top view, (b) is a perspective view, (c) is a side view, and (d) is a front view.

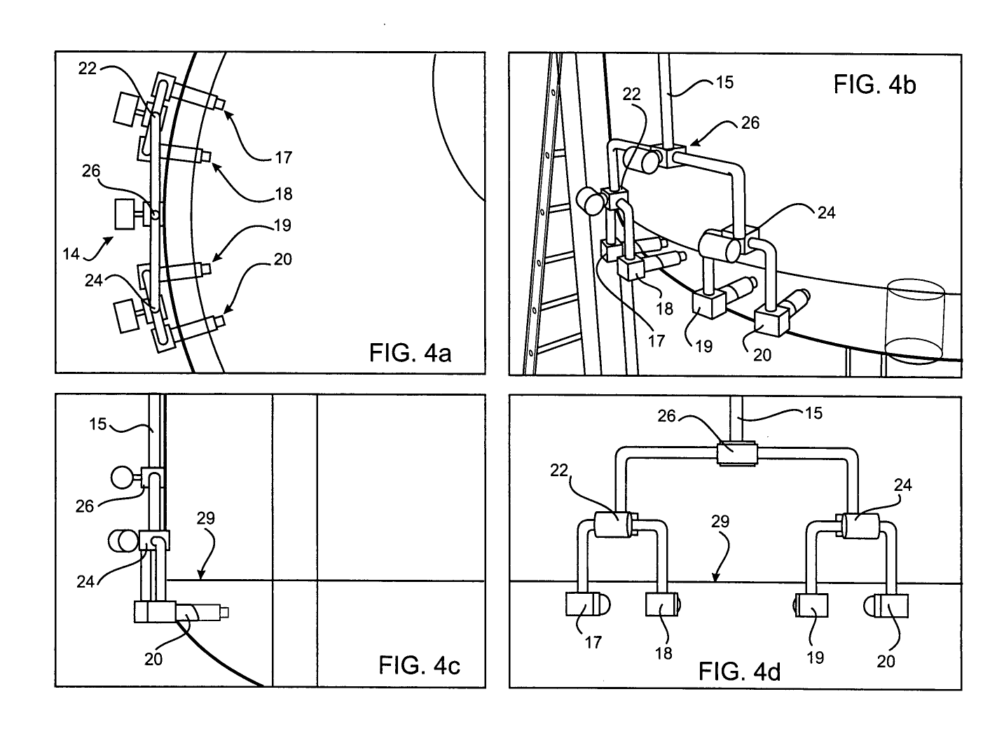

### DETAILED DESCRIPTION OF THE PREFERRED EMBODIMENTS

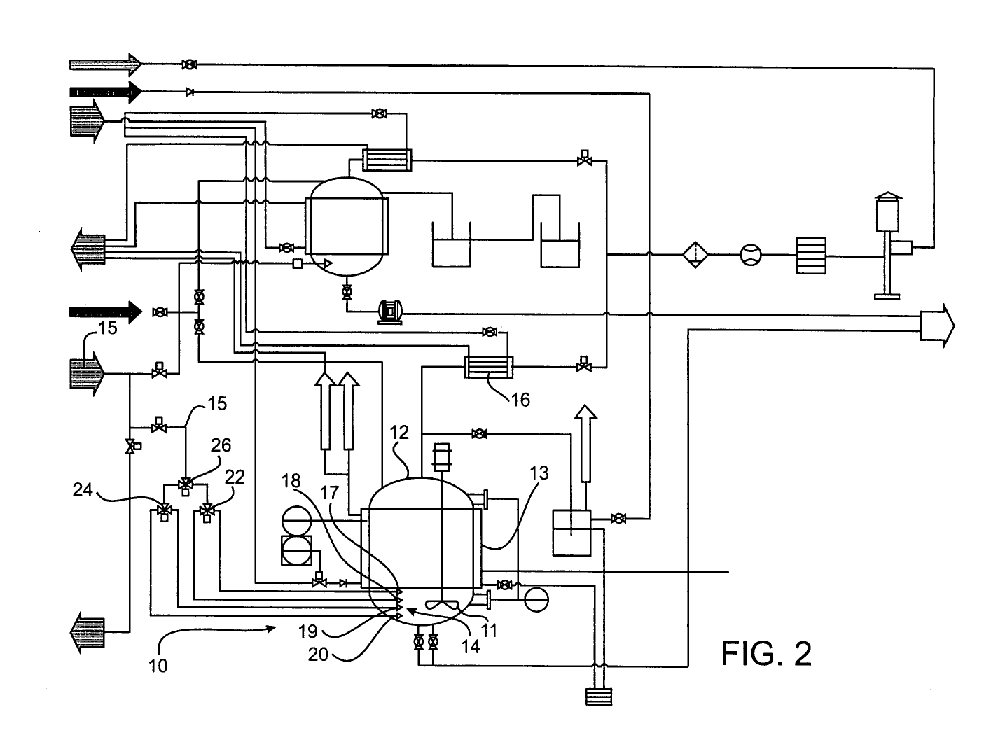

FIG. 2 shows a preferred embodiment of an assembly 10 for reducing pressure of slurry exiting the supercritical reactor 116 via its outlet pipe 15. The assembly 10 includes a sealed collection vessel 12 having a cooling jacket 13 extending around its periphery, and an orifice assembly 14 as its inlet. The assembly 10 includes a condenser 16 above the tank for stopping flashing steam and volatile oil. The orifice assembly 14 includes first to fourth orifices 17 to 20 connected in parallel to the reactor outlet pipe 15.

First and second orifices 17 and 18 are connected to a first valve 22 which is operable to selectively direct flow to the orifice 17 or the orifice 18. Similarly, third and fourth orifices 19 and 20 are connected to a second valve 24 which is operable to selectively direct flow to the orifice 19 or the orifice 20. The first and second valves 22 and 24 are connected to a third valve 26 which is operable to selectively direct flow to the first valve 22 or the second valve 24. The third valve 26 is connected to the outlet pipe 15.

The first, second and third valves 22, 24 and 26 are thus operable to selectively direct flow to any one of the orifices 17 to 20. In the orifice assembly 14, the orifices 17 to 20 have different orifice diameters and/or shapes. In one embodiment, the orifice diameter increases from the orifice 17 to the orifice 20. Alternatively, two or more of the orifices 17 to 20 can have the same orifice diameter and shape. As a further alternative, the orifices 17 to 20 can be fixed or variable diameter micro orifices. In another embodiment, respective nozzles are connected to the orifices 17 to 20, the nozzles having different or the same orifice diameters as desired.

The vessel 12 contains water 29 such that each orifice 17 to 20 discharges slurry under water in use. In one embodiment, the slurry passes through the orifice assembly 14 at a pressure of up to 300 bar after initial cooling of the slurry to a minimum of 180° C. to stop coagulation of the slurry. In other embodiments where variable orifice or ceramic valves are used, it is not necessary to cool the slurry and the slurry passes through the orifice assembly 14 at full pressure and temperature. The orifices 17 to 20 create backpressure against the slurry pump 114 which in the embodiment is a variable speed positive displacement feed pump.

The speed of the pump 114 is used to modulate slurry flow rate in the pipe 15, and is matched to one of the orifices 17 to 20 of appropriate size and shape to achieve the desired pressure exiting the orifice assembly 14. The speed of the pump 114 is controlled automatically to maintain a desired slurry pressure in the slurry processing apparatus 110.

The slurry pressure is monitored at four spaced pressure tapping points throughout the slurry processing apparatus 110. The pressure tappings are constantly monitored and an alarm sounds if the pressure difference is greater than 5 bar between any two points. The speed of the pump 114 is then increased or decreased as appropriate to substantially maintain the desired slurry pressure.

The orifice assembly 14 as above allows orifices or nozzles connected thereto to be selected as required. For example, if one of the orifices 17 to 20 starts to wear, or the nozzles connected to same start to wear, the next orifice/nozzle can automatically be engaged and the worn orifice/nozzle turned off and replaced if desired. Also, if slurry conditions change (e.g. pump speed increases to maintain pressure) outside a given outlet speed for a particular orifice/nozzle, a suitable other orifice/nozzle can be selected from the orifice assembly 14. This allows the desired slurry pressure to be maintained in the apparatus 110.

The orifices 17 to 20 are positioned to discharge under water to keep them cool (under 80° C.). Also, the oils and carbon in the slurry are immediately quenched and remain as small particles and in suspension. The instant cooling also traps the more volatile oils in the water as an emulsion and reduces the possibility of oxidation of the fresh oils. Positioning the orifices under water also has benefits in stopping flash steam at the orifice outlet that may supersonically choke the orifice.

The temperature of the slurry discharged at the orifice assembly 14 is maintained above the softening point of the process slurry constituents to avoid formation of compounds that may de-stabilize orifice/nozzle performance or potentially form orifice/nozzle blockages. Orifice discharge temperatures typically range from 120° C. minimum to about 240° C. maximum.

The vessel 12 operates as a heat exchanger, maintaining temperatures above the softening & solidification points of various product slurry constituents to facilitate material handling. This also ensures the process temperature is suitable for downstream processing equipment. The vessel 12 includes a mixer 11 for agitating its contents to maintain same homogenized and avoid fractionation.

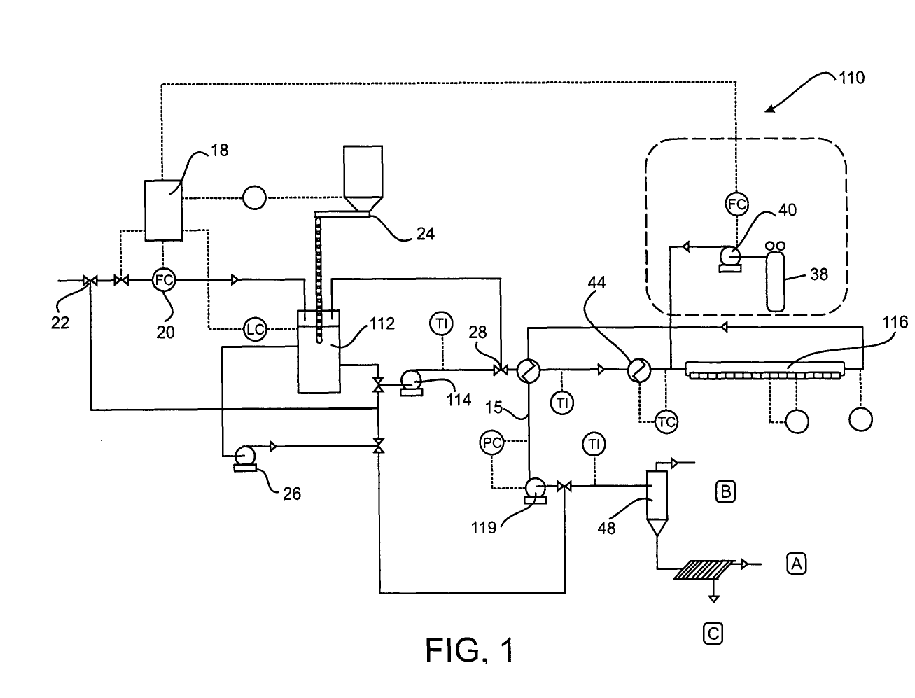

The apparatus shown in FIG. 1 is for a pilot plant running at 2 Litres per minute (LPM) with the commercial modules envisaged to run at 30 LPM.

The orifices 17 to 20 alter slurry process conditions from high pressure, low velocity flow to low-pressure, high velocity flow. The transformation of pressure energy to kinetic energy at the orifice discharge enhances slurry processing as follows:
The orifice geometry creates high shear stresses in the slurry passing through the orifice. This effectively grinds the process slurry particles together as they pass through the orifice, reducing the particle size from 80 micron down to about 5 micron. This produces solid products (char) with a high specific surface area that is immediately useful for industry (e.g. coking, filtration, combustion fuel applications). Further processing to reduce the particle size to add value to the product is unnecessary.
The discharge velocities (typically ranging from 140 m/s-200 m/s) create severe turbulence in the discharge zone within the vessel. This aids to further grind the slurry media into small particle sizes, and enhances the heat transfer efficiency from the captured process slurry to the cooling jacket water.
The pressure drop across the orifices is sufficient to cause steam flashing of process liquids after discharging at elevated temperatures. The steam bubbles condense when introduced to the cooled environment, causing cavitation & turbulence to assist the grinding of solid media.

Although preferred embodiments of the present invention have been described, it will be apparent to skilled persons that modifications can be made to the embodiments described.

1. An assembly for reducing pressure of slurry exiting an outlet pipe of a supercritical reactor, the assembly including:
a sealed collection vessel; and
an orifice assembly forming an inlet of the collection vessel, wherein the orifice assembly comprises a plurality of orifices for parallel connection with the reactor outlet pipe, wherein flow from the outlet pipe can be directed to any one of the orifices.

2. The assembly of claim 1 wherein the sealed collection vessel includes a cooling jacket extending around its periphery.

3. The assembly of claim 1 wherein the orifice assembly comprises first to fourth orifices of differing orifice diameters and/or shapes.

4. The assembly of claim 3 wherein the first and second orifices are connected to a first valve which is operable to selectively direct flow to one of the first and second orifices, the third and fourth orifices are connected to a second valve which is operable to selectively direct flow to one of the third and fourth orifices, and the first and second valves are connected to a third valve which is operable to selectively direct flow to one of the first and second valves, the third valve being for connection to the reactor outlet pipe.

5. The assembly of claim 1 wherein the orifices have increasing diameters.

6. The assembly of claim 1 wherein two or more of the orifices have the same orifice diameter.

7. The assembly of claim 1 wherein the sealed vessel contains water in use such that each orifice discharges slurry under water in use.

8. The assembly of claim 1 wherein the orifices are fixed or variable diameter micro orifices.

9. The assembly of claim 1 wherein respective nozzles are connected to the orifices.

10. The assembly of claim 9 wherein the nozzles have different orifice diameters.

11. The assembly of claim 9 wherein at least two of the nozzles have the same orifice diameter.

12. The assembly of claim 1 wherein the slurry is fed to the orifices via a slurry pump, the slurry pump being a variable speed positive displacement feed pump.

13. A method of substantially maintaining slurry pressure exiting an outlet pipe of a supercritical reactor to a desired pressure in an assembly in accordance with claim 12, the method comprising the steps of:
increasing or decreasing the rate at which the slurry pump feeds the slurry into the orifice assembly; and
selecting an orifice in the orifice assembly having suitable orifice diameter and shape to maintain the desired slurry pressure.

14. The method of claim 13 further including the step of monitoring slurry pressure at spaced points throughout the processing assembly and, if slurry pressure changes between any two points more than a predetermined amount, increasing or decreasing the slurry pump rate and/or selecting a different orifice in the orifice assembly in response to said pressure change.

15. The method of claim 13 wherein nozzles are respectively attached to the orifices and the selection step includes selecting a nozzle having a suitable orifice diameter and shape to maintain the desired slurry pressure.

16. (canceled)

17. (canceled)
